(19) United States
(12) Patent Application Publication
(10) Pub. No.: US 2017/0076140 A1
(43) Pub. Date: Mar. 16, 2017

(54) WEARABLE CAMERA SYSTEM AND METHOD OF NOTIFYING PERSON

(71) Applicant: Panasonic Intellectual Property Management Co., Ltd., Osaka (JP)

(72) Inventors: Kazuya WANIGUCHI, FUKUOKA (JP); Minoru HAGIO, FUKUOKA (JP)

(21) Appl. No.: 15/261,232

(22) Filed: Sep. 9, 2016

(30) Foreign Application Priority Data
Sep. 14, 2015 (JP) 2015-181128
Jan. 25, 2016 (JP) 2016-011788

(51) Int. Cl. G06K 9/00; H04N 21/414; G06F 1/16; H04N 5/232

(52) U.S. Cl. CPC G06K 9/00255; H04N 5/23293; H04N 21/41407; H04N 21/41422; G06K 9/00268; G06K 9/00288; G06F 1/163; G06K 9/00791

(57) ABSTRACT

An on-vehicle camera system captures a subject, detects a face of a person included in a captured image of the captured subject, and transmits information on the detected face to the server. The server receives the information on the face, collates information on a face of a person involved in an incident which is registered in advance with the received information on the face, and notifies the wearable camera of the information on the person involved in the incident in a case where the received information on the face is matched with the information on the face of the person involved in the registered incident from the result of the collation.

### BACKGROUND

Technical Field

The present disclosure relates to a wearable camera system which notifies a person having a wearable camera mounted on a garment or a person carrying a wearable camera of a person appearing in a video captured by a wearable camera and a method of notifying person.

Description of the Related Art

Recently, in order to efficiently assist police officers with their services, a system in which police officers have a wearable camera mounted on a uniform or carry a wearable camera at the time of patrolling, for example has been examined.

As a related art using a wearable camera, a wearable monitoring camera system disclosed in Japanese Patent Unexamined Publication No. 2006-148842 is exemplified. The wearable monitoring camera system disclosed in Japanese Patent Unexamined Publication No. 2006-148842 has a configuration in which an image (video) signal and a sound signal from a CCD camera and a microphone which are wearable, and a date and time information signal from a built-in clock are encoded by an encoding server which can be accommodated in a wearable pouch, and then date and time information which is converted into text information is superimposed on a captured image so as to record the aforementioned information.

Here, a case where the wearable camera disclosed in Japanese Patent Unexamined Publication No. 2006-148842 is used by being mounted on a uniform of a police officer is assumed. It is assumed that in the case where the police officer has the aforementioned wearable camera mounted on his or her uniform, upon finding a monitoring subject such as a suspicious person or a stolen car, the police officer pushes a recording switch so as to start recording image data (an image signal).

However, in the configuration of Japanese Patent Unexamined Publication No. 2006-148842, when the police officer having the wearable camera mounted on his or her uniform patrols or is dispatched to a site of incident, the wearable camera does not inform whether or not there is a suspicious person (for example, a suspicious person and a suspect concerning the incident), and thus it is difficult for the police officer to instantly determine the existence of the suspicious person. In addition, even when the police officer recognizes a face of a suspect, the police officer cannot correctly determine whether or not a person close to the police officer is the aforementioned suspect in some cases. In this case, if the aforementioned suspect is the person close to the police officer, the police officer is to immediately protect him or herself.

### BRIEF SUMMARY

The present disclosure is made in consideration of the above described circumstances, and an object thereof is to provide a wearable camera system which efficiently assists police officers with their services by rapidly notifying the police officers that there is a suspicious person in the vicinity, and a method of notifying a person.

According to an aspect of the present disclosure, there is provided a wearable camera system including: a wearable camera which belongs to a user; an on-vehicle camera system which is installed on a patrol car or the like, and is capable of communicating with the wearable camera; and a server which is capable of communicating with the wearable camera and the on-vehicle camera system, in which the on-vehicle camera system captures a subject, detects a face of a person included in a captured image of the captured subject, and transmits information on the detected face to the server, in which the server receives the transmitted information on the face, collates information on a face of a person involved in an incident which is registered in advance with the received information on the face, and notifies the wearable camera of the information on the person involved in the incident in a case where the received information on the face is matched with the information on the face of the person involved in the registered incident from the result of the collation, and in which the wearable camera notifies the user of the notified information on the person.

According to the present disclosure, the wearable camera system can rapidly notify police officers that there is a suspicious person in the vicinity, and thus can efficiently assist police officers with their services.

### BRIEF DESCRIPTION OF THE SEVERAL VIEWS OF THE DRAWINGS

FIG. 1 is an explanatory diagram illustrating an example of an outline of a wearable camera system of the exemplary embodiment;

FIG. 2 is a diagram illustrating an example of an upper body of a police officer wearing a uniform with a wearable camera of the exemplary embodiment;

FIG. 3 is a front view illustrating an example of a front-side surface of a housing of the wearable camera of the exemplary embodiment;

FIG. 4 is a rear view illustrating an example of a rear-side surface of the housing of the wearable camera of the exemplary embodiment;

FIG. 5 is a block diagram illustrating an example of an internal configuration of the wearable camera of the exemplary embodiment;

FIG. 6 is a block diagram illustrating an example of an internal configuration of an on-vehicle camera system of the exemplary embodiment;

FIG. 7 is a block diagram illustrating an example of an internal configuration of a back end server of the exemplary embodiment;

FIG. 8 is a diagram illustrating an example of an operation outline of the wearable camera system of the exemplary embodiment;

FIG. 9 is a sequence diagram illustrating an example of procedure of a specific operation of the wearable camera system of the exemplary embodiment;

FIG. 10A is a diagram illustrating a configuration example of cut-out data of the exemplary embodiment;

FIG. 10B is a diagram illustrating a configuration example of recording data after notification in the exemplary embodiment;

FIG. 11 is a diagram illustrating an example of registration contents in a table in which operations of the wearable camera corresponding to levels of importance after notification is registered;

FIG. 12 is a sequence diagram illustrating another example of procedure of a specific operation of the wearable camera system of the exemplary embodiment; and

FIG. 13 is an explanatory diagram specifically illustrating an example of face recognition data of the exemplary embodiment.

FIG. 14 is a diagram illustrating a display example of a screen displayed on a wearable camera or a smart phone of the modification example.

FIG. 15 is a diagram illustrating an example of a correspondence table of police officers of a team to which police officer A belongs and wearable cameras used by the police officers of the aforementioned team.

FIG. 16 is a sequence diagram illustrating an example of a specific operation procedure of a wearable camera system of the modification example.

### DETAILED DESCRIPTION

Hereinafter, embodiments (hereinafter, referred to as the exemplary embodiment) which specifically disclose a wearable camera system and a method of notifying person information relating to the present disclosure will be described in detail by properly referring to the drawings. Note that, detailed description more than necessary may be omitted. For example, there may be omitted a detailed description of the already well-known matters and a duplicate description of substantially the same structure. This is to avoid that the following description is unnecessarily redundant, and to facilitate the understanding of those skilled in the art. It should be noted that the inventors of the present disclosure provide the accompanying drawings and the description below so that those skilled in the art fully understand the present disclosure, and do not intend to limit the subject matter described in the claims by these.

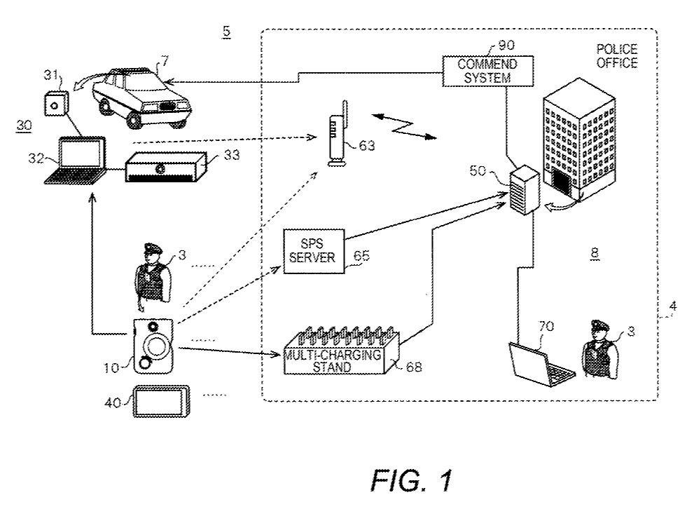

FIG. 1 is an explanatory diagram illustrating an example of an outline of wearable camera system 5 of the exemplary embodiment. Wearable camera system 5 is configured to include on-vehicle camera system (in car video system (ICV)) 30 which is mounted on patrol car 7, wearable camera 10 which is mounted on a uniform of police officer 3, and in-office system 8 installed in the inside of police office 4.

On-vehicle camera system 30 includes one or more of on-vehicle cameras 31, on-vehicle personal computer (PC) 32, and on-vehicle recorder 33, and captures a video based on captured images of an incident happened when police officers patrol by driving patrol car 7 so as to record the incident. One or more of on-vehicle cameras 31 include one or more cameras among a camera which is installed so as to capture the front of a patrol car, and cameras which are respectively installed so as to capture the left, the right, and the rear of the patrol car. On-vehicle PC 32 controls operations of on-vehicle camera 31 and on-vehicle recorder 33 in accordance with an instruction operated by police officer 3. On-vehicle recorder 33 records video data captured by each on-vehicle camera 31 in the time series.

On-vehicle camera system 30 is wirelessly connected to back end server (BES) 50 in in-office system 8, selects specific video data from the items of video data recorded in on-vehicle recorder 33, and is capable of transmitting cut-out data (refer to the following description) to back end server 50. In addition, on-vehicle camera system 30 is communicably connected to wearable camera 10, and records the video data captured by wearable camera 10 in on-vehicle recorder 33.

Wearable camera 10 which is mounted on the uniform of police officer 3 captures the front of the police officer as a subject, and transmits the captured video data to on-vehicle camera system 30. Hereinafter, a subject which is supposed to be a capturing target of wearable camera 10 and on-vehicle camera 31 includes not only a person, but also a scene of a site of an incident, crowds gathering near the site (so-called, onlookers), and atmosphere around a capturing position. In addition, police officer 3 carries smart phone 40 which is capable of communicating with wearable camera 10. Smart phone 40 has a telephone function and a wireless communication function, and is one example of a portable terminal which is generally used to contact with the police office in emergency situations. Wearable camera 10 is connected to back end server 50 via on-vehicle camera system 30, directly, or via smart phone 40 so as to transmit video data to back end server 50. In addition, wearable camera 10 is manually attached to multi-charging stand 68 described below so as to transmit the video data to back end server 50.

In-office system 8 which is installed in the inside of police office 4 includes back end server 50, streaming proxy server (SPS) 65, client PC 70, wireless LAN access point 63, multi-charging stand 68, and command system 90.

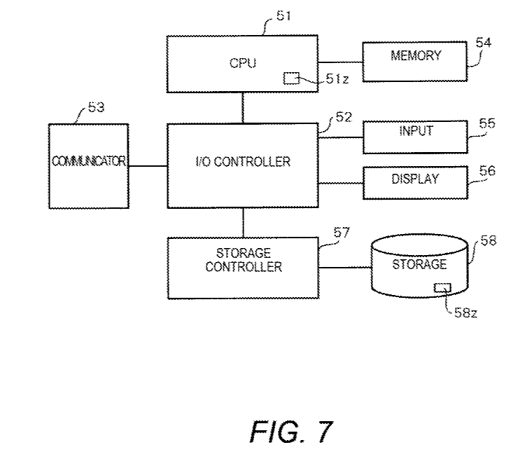

Back end server 50 has a face recognition function of recognizing a face of a person appearing in the captured image of face image data or face recognition data (refer to the following description) included in cut-out data which is transmitted from wearable camera 10 or on-vehicle camera system 30, and manages evidence videos of incidents. In addition, back end server 50 includes suspicious person database 58z (refer to FIG. 7) in which a person on the wanted list, an ex-convict, or the like is previously registered by corresponding to information for identifying incidents (for example, case number). Back end server 50 recognizes the face of the person in the face image data or the face recognition data which is included in the cut-out data transmitted from on-vehicle camera system 30 or wearable camera 10, and then collates a person having the recognized face with a person registered in suspicious person database 58z. Note that, storage 58 which stores suspicious person database 58z may be installed in the inside or the outside of police office 4 as long as storage 58 is accessible to back end server 50.

Streaming proxy server 65 receives the video data which is streaming-distributed from wearable camera 10, and transfers video data to back end server 50. In addition, streaming proxy server 65 may receive the video data which is streaming-distributed from on-vehicle camera system 30 and transfer the video data to back end server 50.

Client PC 70 includes a browser which accesses suspicious person database 58z of back end server 50, and searches information on a criminal or the like of the incident so as to display the detected result on a display device (for example, liquid crystal display (LCD) which is previously provided in client PC 70). Note that, client PC 70 may be installed not only in the inside of police office 4 but also in the outside of the police office 4. Further, client PC 70 may be any one of a thin client PC and a rich client PC.

Wireless LAN access point 63 is wirelessly connected to on-vehicle camera system 30 and wearable camera 10, and transfers the video data recorded in on-vehicle camera system 30 and the video data recorded in wearable camera 10 to back end server 50.

Multi-charging stand 68 on which wearable cameras 10 which are mounted on the uniforms of police officers 3 or carried by police officers 3 can be mounted has functions of charging the mounted wearable cameras 10 and transmitting the video data stored in wearable camera 10 to back end server 50 by performing wire communication with wearable camera 10. In addition, multi-charging stand 68 is wiredly connected to back end server 50 via a universal serial bus (USB) cable.

Command system 90 is connected to back end server 50, and in a case where an incident happens, in accordance with an instruction from back end server 50, command system 90 transmits various dispatch commands to the patrol car in which the police officer who is supposed to dispatch to the site of the incident such that the police officer rushes to the site of the incident so as to secure the site and a suspect, and support the police officers having arrived at the site. In accordance with the instruction which is input-operated by the police officer, command system 90 may transfer the command to the police officer who is supposed to dispatch to the site of the incident. In addition, command system 90 may not be directly connected to back end server 50, and in a case where the incident happens, command system 90 may wirelessly transmit various dispatch commands to the patrol car in which the police officer who is supposed to dispatch to the site of the incident without depending on back end server 50.

In wearable camera system 5, wearable camera 10 is connected to on-vehicle camera system 30 so as to transfer data via near field communication or by using a signal cable such as USB. The video data captured by wearable camera 10 is transferred to on-vehicle camera system 30, is played or recorded by on-vehicle camera system 30, and then is transmitted to back end server 50.

On-vehicle camera system 30 records a video captured by on-vehicle camera 31 and a video captured by wearable camera 10 in on-vehicle recorder 33, and detects the face of the person included in the videos. On-vehicle camera system 30 cuts out a rectangular image (that is, a face image) including the aforementioned face, or cuts out information on face features as the detected information on the face of the person. On-vehicle camera system 30 transmits cut-out data including the cut-out face image (that is, face image data) or information on the face features (that is, face recognition data) to back end server 50 via a wireless local area network (LAN). For example, in a case where police officer 3 patrols alone by driving patrol car 7, the suspicious person (for example, the suspect of the incident) may be in the vicinity of patrol car 7; however, the suspicious person is not in front of police officer 3, and thus is not recognized by police officer 3. In such a case, on-vehicle camera system 30 transmits cut-out data including a face image or information on the face features to back end server 50, and wearable camera 10 receives notification from back end server 50 as described below. With this, even in a case where police officer 3 cannot recognize the suspicious person in the vicinity of the outside of patrol car 7 in person, police officer 3 can rapidly recognize the existence of the suspicious person by the notification (for example, vibration of vibrator 27 and display on LCD 28) from wearable camera 10, and can perform an appropriate action. In this case, on-vehicle camera 31 and wearable camera 10 which correspond to each other are stored in a memory in advance, and the recognition result of the face image which is cut out from the video captured by on-vehicle camera 31 is notified to wearable camera 10 corresponding to on-vehicle camera 31 which are registered in the memory. That is, the fact that the suspicious person is in the vicinity of the patrol car is notified to wearable camera 10 mounted on the uniform of the police officer in the patrol car on which on-vehicle camera 31 is mounted.

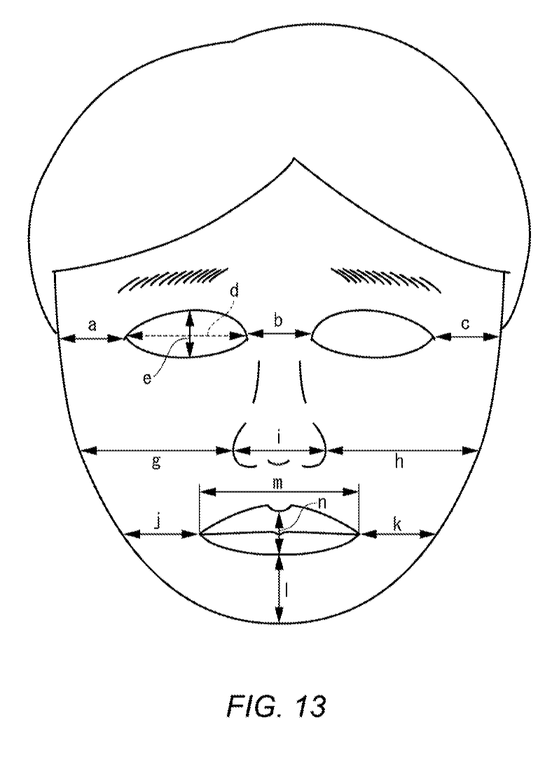

Similarly, wearable camera 10 detects the face of the person included in the captured video, cuts out the rectangular image including the aforementioned face (that is, the face image), or cuts out the information on the face features as the detected information on the face of the person. Wearable camera 10 can transmit the cut-out data including the cut-out face image (that is, face image data) or the information on the face features (that is, face recognition data) with the video data to back end server 50 via the wireless LAN, or can directly transmit the cut-out data including the cut-out face image or the information on the face features without the video data. Note that, the shape of the cut-out of the face image is not limited to a rectangle, but may be any shape such as circle, ellipse, and other polygons. In addition, details of the information on the face features will be described below with reference to FIG. 13.

Further, police officer 3 who returns to police office 4 mounts wearable camera 10 on multi-charging stand 68, and multi-charging stand 68 charges wearable camera 10, and can transmit the cut-out data recorded in wearable camera 10 to back end server 50 via a USB cable.

When receiving the cut-out data from the on-vehicle camera system 30 and wearable camera 10, back end server 50 recognizes the face features from the face image included in the cut-out data by using a face recognition function so as to obtain the information on the face features, or specifies the information on the face features from face recognition data included in the cut-out data. Back end server 50 collates the face of the person registered in suspicious person database 58z which is registered in advance with the face of the person specified by the information on the face features by using the information on the face features, and notifies on-vehicle camera system 30 and wearable camera 10 of the result of the collation.

In addition, when police officer 3 requires back end server 50 to perform process of searching the person involved in the incident by operating client PC 70, and back end server 50 searches the person registered in suspicious person database 58z in accordance with the request from client PC 70.

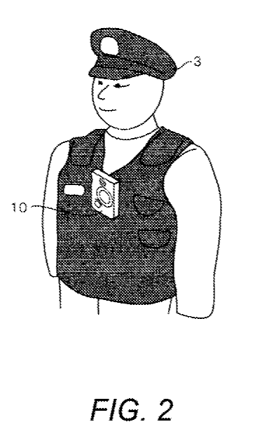

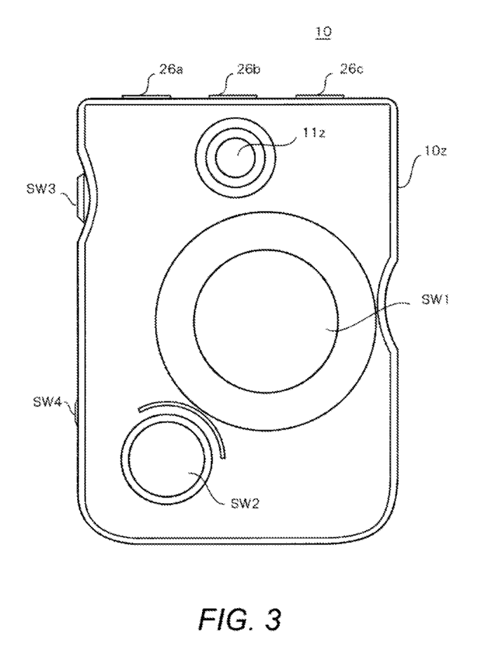

FIG. 2 is a diagram illustrating an example of an upper body of police officer 3 wearing a uniform with wearable camera 10 of the exemplary embodiment. Wearable camera 10 is placed on a front portion of the uniform of police officer 3 so as to capture the front of police officer 3. For example, wearable camera 10 may be fixed on the front portion of the uniform in a state of hanging on a string from the neck, or may be fixed on the front portion of the uniform by causing a mounting tool (for example, a mounting clip) attached to the rear surface of housing 10z (refer to FIG. 3) of wearable camera 10 to engage with a mounted tool which is attached on the front portion of the uniform.

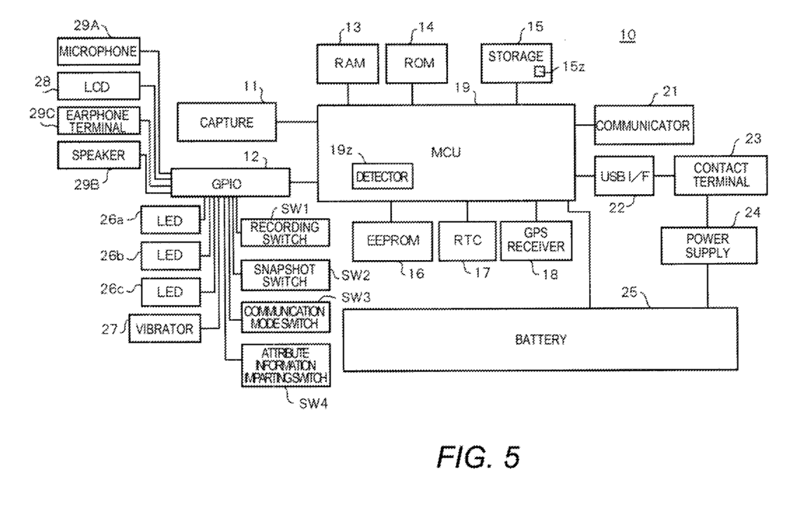

FIG. 3 is a front view illustrating an example of a front-side surface of housing 10z of wearable camera 10 of the exemplary embodiment. Recording switch SW1, snapshot switch SW2, and imaging lens 11z are disposed on the surface of the front side of housing 10z. A short press of recording switch SW1 instructs that the recording is started, and a long press (for example, an operation in which pressing state is continued for three seconds) of recording switch SW1 instructs that the recording is stopped. Snapshot switch SW2 instructs that a still image captured by capture 11 is recorded whenever being pressed. Imaging lens 11z forms an optical image of a subject to be captured by wearable camera 10 on an imaging area of capture 11 (refer to FIG. 5).

Communication mode switch SW3 and attribute information imparting switch SW4 are disposed on the side surface of housing 10z. Three LEDs 26a, 26b, and 26c are disposed on the upper surface of housing 10z. LED 26a displays a state of turning on or off of power of wearable camera 10 and a state of battery 25 (refer to FIG. 5). LED 26b displays a state of an imaging operation of wearable camera 10. LED 26c displays a state of a communication mode of wearable camera 10.

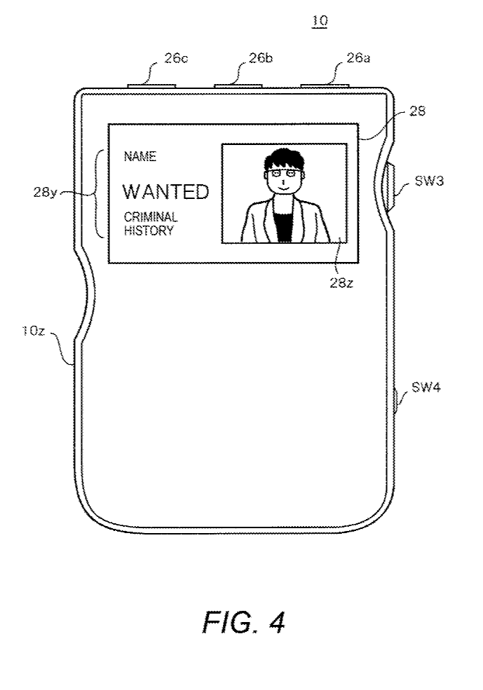

FIG. 4 is a rear view illustrating an example of a rear-side surface of housing 10z of wearable camera 10 of the exemplary embodiment. Liquid crystal display (LCD) 28 is disposed on the surface on the rear side of housing 10z. LCD 28 is disposed in a state of being shifted upward from substantially at the center of the surface on the rear side of housing 10z, and LCD 28 has a small blank space (that is, a gap part) from the upper end thereof. With this, when police officer 3 arrives at the site of the incident and patrols, or police officer 3 encounters the person judged to be definitely suspicious, police officer 3 easily looks into wearable camera 10 mounted on the front portion of the uniform, and instantly confirms whether or not the encountered person is the suspicious person, as compared with the case where the screen of LCD 28 disposed on the rear surface of the housing 10z is disposed substantially at the center of the surface on the rear side. Face image 28z and specific information 28y of the suspicious person are displayed on the screen of LCD 28. In a case where the information on the suspicious person is registered in suspicious person database 58z of back end server 50, face image 28z of the suspicious person displayed on the screen LCD 28 is supposed to be a mug shot registered in back end server 50. In addition, specific information 28y includes information such as a name, a history of being on the wanted list, and a history of criminal. In a case where the information on the suspicious person is registered in suspicious person database 58z of back end server 50, face image 28z of the suspicious person as illustrated in FIG. 4 is not displayed on the screen of LCD 28, but for example, the information on the suspicious person may be indicated by any one of text, color flashing, and color lighting, or in combination thereof. With this, police officer 3 can instantly confirm that the person in front of him or herself is the suspicious person, and thus can prepare appropriate actions as a police officer with respect to the suspicious person.

On the other hand, in a case where the information on the suspicious person is not registered in suspicious person database 58z of back end server 50, face image 28z of the person displayed on the screen of LCD 28 is supposed to be the face image cut out from the captured image by wearable camera 10. That is, the face image included in the cut-out data. In this case, specific information 28y is not displayed (that is, blank). Even in a case where the face image data is not included in the cut-out data which is transmitted from wearable camera 10 to back end server 50, the face image data which is cut out from the captured image by wearable camera 10 may be displayed on the screen of LCD 28. In addition, in the case where the information on the suspicious person is not registered in suspicious person database 58z of back end server 50, wearable camera 10 may not display the face image on the screen of LCD 28. In this case, police officer 3 can easily confirm that if a face image of a person is not displayed on the screen of LCD 28, the person is not registered in suspicious person database 58z, and thus can prepare appropriate actions with respect to a person who is not on a wanted list and has a criminal history. Further, the position of LCD 28 is not limited to the upper portion of the surface on the rear side of the housing as long as the suspicious person cannot easily find the position of LCD 28, and the police officer can easily look into the screen. For example, LCD 28 may be disposed on the surface of the upper end of the housing. In the case where the LCD may be disposed on the surface of the upper end of the housing, the police officer can look into the screen of LCD 28 only by slightly lowering the head, and thus it is possible to reduce the frequency of unnecessary vigilance of the suspicious person who is in front of police officer 3.

FIG. 5 is a block diagram illustrating an example of an internal configuration of wearable camera 10 of the exemplary embodiment. Wearable camera 10 is provided with capture 11, general purpose input/output (GPIO) 12, random access memory (RAM) 13, read only memory (ROM) 14, and storage 15. Wearable camera 10 is provided with electrically erasable programmable rom (EEPROM) 16, real time clock (RTC) 17, and global positioning system (GPS) receiver 18. Wearable camera 10 is provided with micro controller unit (MCU) 19, communicator 21, universal serial bus (USB) interface (I/F) 22, contact terminal 23, power supply 24, and battery 25.

Wearable camera 10 is provided with recording switch SW1, snapshot switch SW2, communication mode switch SW3, and attribute information imparting switch SW4.

Wearable camera 10 is provided with three light emitting diodes (LED) 26a, 26b, and 26c, and vibrator 27.

Capture 11 includes imaging lens 11z (refer to FIG. 3), and a solid-state image sensing element formed of a charge coupled device (CCD) type image sensor or a complementary metal oxide semiconductor (CMOS) type image sensor. Capture 11 outputs the captured image data of the subject to MCU 19.

GPIO 12 is a parallel interface. Recording switch SW1, snapshot switch SW2, communication mode switch SW3, attribute information imparting switch SW4, LEDs 26a to 26c, vibrator 27, LCD 28, earphone terminal 29C as an example of a sound output terminal, speaker 29B, and microphone 29A are connected to GPIO 12. GPIO 12 inputs and outputs signals between the aforementioned electronic components and MCU 19. For example, microphone 29A collects ambient sounds, and outputs the collected audio data to MCU 19 via GPIO 12.

RAM 13 is a work memory which is used to operate, for example, MCU 19. ROM 14 stores program and data in advance so as to control, for example, MCU 19.

Storage 15 is formed of a storing medium such as a memory card, and starts recording the captured video by capture 11 in accordance with the instruction to automatically or manually start the recording. Further, storage 15 includes setting data file 15z in which information for resolution enhancement is set. For example, in the case where storage 15 is formed of the memory card, storage 15 is removably inserted into the housing 10z of wearable camera 10.

EEPROM 16 stores, for example, identification information (for example, a serial number as a camera ID) for identifying wearable camera 10, and various types of setting information. RTC 17 counts the current time and outputs the information on the current time to MCU 19.

GPS receiver 18 as one example of the position information acquisitor receives position information and time information of current wearable camera 10 (master device) from a GPS transmitter (not shown), and outputs to MCU 19. The time information is also used to correct a system time of wearable camera 10. The system time is used to record a capturing time of the captured image (including a still image and a video).

MCU 19 serves as a controller of wearable camera 10, for example, and performs a control process of controlling the entire operations of the respective portions of wearable camera 10, a data input and output process between the respective portions of wearable camera 10, a data computing (calculating) process, and a data storing process. MCU 19 is operated in accordance with the program and data stored in ROM 14. MCU 19 acquires the information on the current time from RTC 17 by using RAM 13 during the operation, and acquires information on the current position from GPS receiver 18.

MCU 19 as one example of a face cut-out includes detector 19z as one example of a face detector, detects the face of the person included in the image captured by capture 11 by using detector 19z, and cuts out a rectangular image (that is, face image data) including the aforementioned face as the information on the face.

In addition, MCU 19 causes detector 19z as one example of a face information identifier to identify the information on the face features of the person which appears in the cut-out face image data, and cuts out the identified information on the face features as the detected information on the face. In other words, MCU 19 cuts out the face image, specifies the information on the face features (for example, eyes, nose, and mouth) of the person which included in the face image data, and obtains the specification result as the information on the face features so as to generate face recognition data including the information on the face features.

Communicator 21 as one example of a transmitter, for example, regulates the connection between communicator 21 and MCU 19 in a physical layer which is a first layer of an open systems interconnection (OSI) reference model. Communicator 21 performs wireless communication (for example, Wi-Fi (trade mark)) by wireless LAN (W-LAN) in accordance with the aforementioned regulation. Note that, communicator 21 may perform wireless communication such as near field communication (NFC) or Bluetooth (trade mark).

USB interface 22 is a serial bus, and enables the connection between on-vehicle camera system 30 and client PC 70 and the like in the police office.

Contact terminal 23 which is a terminal for electrically connecting to a cradle (not shown) or an external adapter (not shown) is connected to MCU 19 via USB interface 22, and is connected to power supply 24. Battery 25 is charged via contact terminal 23, and contact terminal 23 enables the communication of the image data or the like.

Contact terminal 23 is provided with “charging terminal V+”, “CON.DET terminal”, “data terminals D− and D+” and “ground terminal” (which are not shown). The CON.DET terminal is a terminal for detecting voltage and change of the voltage. Data terminals D− and D+ are terminals for transferring the images captured by wearable camera 10 to an external PC or the like via a USB connector terminal, for example.

When contact terminal 23 is connected to a connector such as the cradle (not shown) or the external adapter (not shown), the date communication can be performed between wearable camera 10 and external device.

For example, power supply 24 supplies electric power supply supplied from the cradle or the external adapter to battery 25 via contact terminal 23 so as to charge battery 25. Battery 25 is formed of, for example, a chargeable secondary battery, and supplies electric power supply to the respective portions of the wearable camera 10.

Recording switch SW1 is a pressing button switch for inputting an operation instruction to start or stop the recording (that is, recording of the captured video) through a pressing operation performed by police officer 3. When recording switch SW1 is pressed odd number of times, the recording (that is, recording of the captured video) is started, and when being pressed even number of times, the recording is finished.

Snapshot switch SW2 is a pressing button switch for inputting an operation instruction to capture a still image through a pressing operation performed by police officer 3. Whenever snapshot switch SW2 is pressed, the still image is captured at the time of being pressed.

Communication mode switch SW3 is a slide switch for inputting an operation instruction to set a communication mode between wearable camera 10 and the external device. The communication mode includes, for example, an access-point mode, a station mode, and an OFF mode.

The access-point mode is a mode in which wearable camera 10 is operated as an access point of the wireless LAN, and is wirelessly connected to smart phone 40 which is carried by police officer 3 such that the communication is performed between wearable camera 10 and smart phone 40. In the access-point mode, smart phone 40 is connected to wearable camera 10, and thus can perform display of the current live image, playback of the recorded image, and display of the captured still image through wearable camera 10.

The station mode is a mode in which the communication is performed with an external device as an access point in a case of connecting to the external device by using the wireless LAN. For example, smart phone 40 is set as an external device by using a tethering function of smart phone 40. In the station mode, wearable camera 10 can perform, for example, various settings and transferring (uploading) of the recorded images kept by wearable camera 10 with respect to on-vehicle camera system 30 or client PC 70 or back end server 50 in police office 4.

The OFF mode is a mode in which a communicating operation of the wireless LAN is off, and the wireless LAN is set to be in an unused state.

Attribute information imparting switch SW4 is a pressing button switch for imparting attribute information to the video data.

LED 26a is a display which displays a power-on state of wearable camera 10 (a state of being turned on and off) and a state of battery 25. LED 26b is a display which displays a state of a capturing operation of wearable camera 10 (a recording state). LED 26c is a display which displays a state of a communication mode of wearable camera 10. In addition, when wearable camera 10 receives notification data from back end server 50, three LEDs 26a to 26c perform a flashing operation in accordance with the instruction from MCU 19. At this time, MCU 19 changes flashing patterns of LEDs 26a to 26c in accordance with the levels of importance of the information on the person included in the notification data.

MCU 19 performs the input and detection of each of recording switch SW1, snapshot switch SW2, communication mode switch SW3, and attribute information imparting switch SW4, and performs processing with respect to the operated switch input.

In a case where the operated input of recording switch SW1 is detected, MCU 19 controls the start or the stop of the imaging operation in capture 11, and stores the image obtained from capture 11 as a video in storage 15.

In a case where the operated input of snapshot switch SW2 is detected, MCU 19 stores the image captured by capture 11 when snapshot switch SW2 is operated as a still image in storage 15.

MCU 19 detects the state of communication mode switch SW3, and operates communicator 21 by the communication mode in accordance with the setting of communication mode switch SW3.

In a case where attribute information imparting switch SW4 is pressed, MCU 19 imparts the attribute information to the cut-out data including the face image which is cut out from the image captured by capture 11.

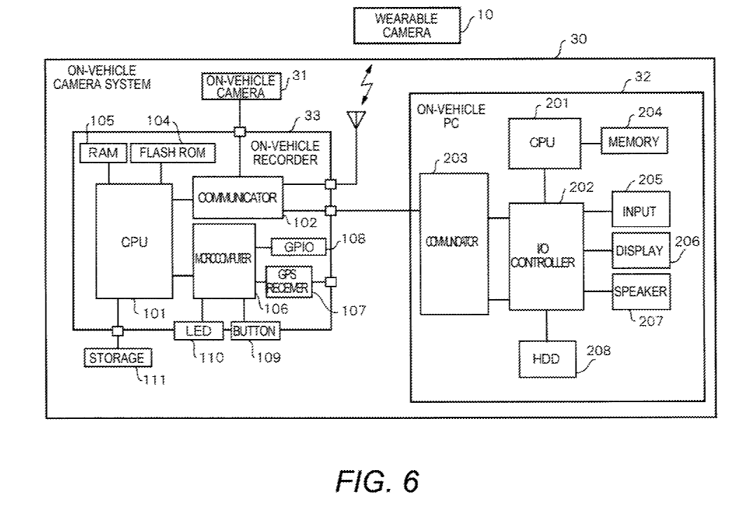

FIG. 6 is a block diagram illustrating an example of an internal configuration of on-vehicle camera system 30 of the exemplary embodiment. On-vehicle camera system 30 is configured to include on-vehicle camera 31, on-vehicle recorder 33, and on-vehicle PC 32.

On-vehicle recorder 33 is configured to include CPU 101, communicator 102, flash ROM 104, RAM 105, microcomputer 106, GPS receiver 107, GPIO 108, button 109, LED 110, and storage 111.

CPU 101 performs a control process of controlling the entire operations of the respective portions of on-vehicle recorder 33, a data input and output process between the respective portions, a data computing (calculating) process, and a data storing process. CPU 101 is operated in accordance with the program and data stored in flash ROM 104.

Communicator 102 wirelessly communicates with an external device via a wireless line or a wired line. Examples of the wireless communication include wireless local area network (LAN) communication, near field communication (NFC), and Bluetooth (trade mark). The wireless LAN communication is performed in accordance with IEEE802.11n regulation of Wi-Fi (trade mark). CPU 101 and communicator 102 are connected to each other via a peripheral component interconnect (PCI) or a USB interface. Wire communication includes wire LAN communication.

Communicator 102 performs the wire communication between on-vehicle camera 31 and on-vehicle PC 32, for example. Communicator 102 performs the wireless communication between wearable camera 10 and client PC 70 and back end server 50 of police office 4. FIG. 6 illustrates an example in which on-vehicle recorder 33 is wiredly connected to on-vehicle camera 31 and on-vehicle PC 32 via communicator 102, and is wirelessly connected to wearable camera 10, but does not illustrate the wireless connection between communicator 102 and client PC 70 and back end server 50 of police office 4. Note that, the face of the person is detected and cut out from the image captured by wearable camera 10, and the process of specifying the information on the face features and generating the face recognition data after cut-out may be performed by CPU 101 of on-vehicle recorder 33. In this case, it is assumed that the captured image data transmitted from wearable camera 10 is received in on-vehicle recorder 33. After that, on-vehicle recorder 33 may transmit the face recognition data, which is formed of the face image data or the information on the face features, as the cut-out data to back end server 50. That is, the cut-out data is not limited to be directly transmitted and received between wearable camera 10 and back end server 50, but may be transmitted and received via on-vehicle recorder 33.

Flash ROM 104 is a memory which stores program and data for controlling, for example, CPU 101. In addition, various types of setting information are stored in flash ROM 104.

RAM 105 is a work memory which is used in the operation of CPU 101. A plurality of RAMs 105 are provided.

Microcomputer 106 which is one type of a microcomputer is connected to the respective portions (for example, GPS receiver 107, GPIO 108, button 109, and LED 110) relating to the external interface, and performs the control relating to the external interface. Microcomputer 106 is connected to CPU 101 via a universal asynchronous receiver transmitter (UART), for example.

GPS receiver 107 receives the information of the current position of on-vehicle recorder 33 and time information from the GPS transmitter (not shown) and outputs to CPU 101. The time information is used to correct the system time of on-vehicle recorder 33.

GPIO 108 is, for example, a parallel interface, and inputs and outputs signals between the connected external device (not shown) and MCU 19 via GPIO 108. Various sensors (for example, a speed sensor, an acceleration sensor, and a door opening and closing sensor) are connected to GPIO 108.

Button 109 includes a recording button for starting or stopping the recording of the image captured by on-vehicle camera 31. Button 109 is not limited to a button type but may be a switch type as long as it is possible to switch states in various ways.

LED 110 displays a power-on state of on-vehicle recorder 33 (a state of being turned on and off), a recording state, a connection state of on-vehicle recorder 33 to LAN, and a usage state of LAN connected to on-vehicle recorder 33, by turning the light on or off, and flashing the light.

Storage 111 is a storage device such as SSD and HDD, and stores the images recorded and captured by on-vehicle camera 31. Storage 111 may store the images recorded and captured by wearable camera 10. Further, storage 111 may store data (for example, audio data collected by on-vehicle camera 31) other than images. Storage 111 is connected to CPU 101 via serial ATA (SATA). A plurality of storages 111 may be provided.

On-vehicle PC 32 is configured to include CPU 201, input/output (I/O) controller 202, communicator 203, memory 204, input 205, display 206, speaker 207, and HDD 208.

On-vehicle PC 32 can communicate with each of wearable camera 10 and on-vehicle recorder 33, and also communicate with each of back end server 50 and client PC 70 of in-office system 8.

CPU 201 performs a control process of controlling the entire operations of the respective portions of on-vehicle PC 32, a data input and output process between the respective portions via I/O controller 202, a data computing (calculating) process, and a data storing process. CPU 201 is operated in accordance with the program and data stored in memory 204.

I/O controller 202 performs control relating to the input and output of data between CPU 201 and the respective portions (for example, communicator 203, input 205, display 206, speaker 207, and HDD 208) of on-vehicle PC 32, and performs relay of the data from CPU 201 and data to CPU 201. Note that, I/O controller 202 may be integrally formed with CPU 201.

Communicator 203 wiredly or wirelessly communicates with on-vehicle recorder 33, wearable camera 10 which is mountable on the uniform of police officer 3, or in-office system 8 side.

Memory 204 which is formed of, for example, RAM, ROM, and nonvolatile or volatile semiconductor memory serves as a work memory during the operation of CPU 201, and stores a predetermined program and data so as to operate CPU 201.

Input 205 is UI which receives an input operation of police officer 3 and notifies CPU 201 of the received input operation via I/O controller 202, and is a pointing device such as a mouse and keyboard. Input 205 which is correspondingly disposed on the screen of display 206 may be formed of a touch panel or a touch pad which can be operated by a finger of police officer 3 or a stylus pen.

Display 206 is formed by using, for example, liquid crystal display (LCD) and organic electroluminescence (EL), and displays various types of information. In addition, display 206 displays an image on the screen under the instruction of CPU 201 in a case where the image which is captured (recorded) by wearable camera 10 is input in accordance with the input operation by police officer 3, for example.

Speaker 207 outputs the sound included in data under the instruction of CPU 201 in a case where the data including the sound which is captured (recorded) by wearable camera 10 is input in accordance with the input operation by police officer 3, for example. Display 206 and speaker 207 may be separately formed from on-vehicle PC 32.

HDD 208 stores, for example, various types of data, and software (a software program). Specifically, HDD 208 stores, for example, software for performing control or setting of on-vehicle recorder 33, and software for performing control or setting of wearable camera 10. In addition, HDD 208 stores, for example, the image which is transferred from wearable camera 10, and captured by wearable camera 10.

FIG. 7 is a block diagram illustrating an example of an internal configuration of back end server 50 of the exemplary embodiment. Back end server 50 is provided with CPU 51, I/O controller 52, communicator 53, memory 54, input 55, display 56, storage controller 57, and storage 58.

CPU 51 performs a control process of controlling the entire operations of the respective portions of back end server 50, a data input and output process between the respective portions, a data computing (calculating) process, and a data storing process. CPU 51 is operated in accordance with the program and data stored in memory 54.

CPU 51 includes recognizer 51z, and performs image authentication and image collation (also referred to as database collation and image matching). In a case where the face image data is included in the cut-out data transferred from wearable camera 10 or on-vehicle recorder 33, in the image authentication, CPU 51 performs face recognition by extracting a specific region (for example, a face image region including the face of the person) to be authenticated from the image, and then extracts the feature of the aforementioned region (that is, information on the face features). Further, in the image collation, CPU 51 as one example of a collator determines in recognizer 51z whether or not the face of the person which is specified by the extracted feature (that is, information on the face features) is matched with the feature (for example, the face image of the suspicious person) which is registered in suspicious person database 58z of storage 58 in advance.

In addition, in the case where the face recognition data is included in the cut-out data transferred from wearable camera 10 or on-vehicle recorder 33, CPU 51 determines in recognizer 51z as one example of a collator whether or not the face of the person which is specified by the information on the face features of face recognition data is matched with the feature (for example, the face image of the suspicious person) which is registered in suspicious person database 58z of storage 58 in advance. Accordingly, in the case where the face image data is included in the cut-out data transferred from wearable camera 10 or on-vehicle recorder 33, processing loads of CPU 51 is reduced as compared with the case where the face image data is included in the cut-out data. With this, CPU 51 can rapidly request for additional dispatch as described below with respect to command system 90, and can rapidly instruct the police officer who is facing a suspicious person or a dangerous person in the site to take an appropriate action.

I/O controller 52 performs control relating to the input and output of data between CPU 51 and the respective portions (for example, communicator 53, input 55, display 56, and storage controller 57) of back end server 50, and performs relay of the data from CPU 51 and data to CPU 51. Note that, I/O controller 52 may be integrally formed with CPU 51.

Communicator 53 wiredly or wirelessly communicates with on-vehicle recorder 33, on-vehicle PC 32, smart phone 40, wearable camera 10 which is mountable on the uniform of police officer 3, or client PC 70.

Memory 54 which is formed of, for example, RAM, ROM, and nonvolatile or volatile semiconductor memory serves as a work memory during the operation of CPU 51, and stores a predetermined program and data so as to operate CPU 51.

Input 55 is UI which receives an input operation of police officer 3 or a person in charge in police office 4, and notifies CPU 51 of the input operation via I/O controller 52, and is a pointing device such as a mouse and keyboard. Input 55 which is correspondingly disposed on the screen of display 56 may be formed of a touch panel or a touch pad which can be operated by a finger of police officer 3 or the person in charge or a stylus pen.

Display 56 is formed by using, for example, LCD and organic EL, and displays various types of information. Display 56 displays an image on the screen under the instruction of CPU 51 in a case where the image which is captured (recorded) by wearable camera 10 is input in accordance with the input operation by police officer 3 or the person in charge, for example. Display 56 displays an image on the screen under the instruction of CPU 51 in a case where the image which is captured (recorded) by on-vehicle camera 31 is input in accordance with the input operation by police officer 3 or the person in charge, for example.

Storage controller 57 performs the control relating to various processes such as access to storage 58, reading, and writing.

Storage 58 is a storage device such as a solid state drive (SSD) and HDD, and stores the images recorded and captured by wearable camera 10 or on-vehicle camera 31. In addition, storage 58 may store data other than image (for example, audio data collected by wearable camera 10 and on-vehicle camera 31). Storage 58 is connected to CPU 51 via serial ATA (SATA).

In addition, storage 58 stores database storing authentication data for authenticating a monitoring target to be captured by wearable camera system 5. Here, suspicious person database 58z in a case of authenticating the face is included as a database. The monitoring target is, for example, a specific person involved in incidents, accidents, crimes, and violations in the past. The face image and the information of the person on the wanted list are registered by the police in suspicious person database 58z as one example of a storage. A face image of the criminal, information on the criminal, and information on the incident caused by the criminal are registered in criminal DB. Further, in a case of authenticating a license number, database for number authentication is included in criminal DB.

An operation of wearable camera system 5 having the above-described configuration will be described.

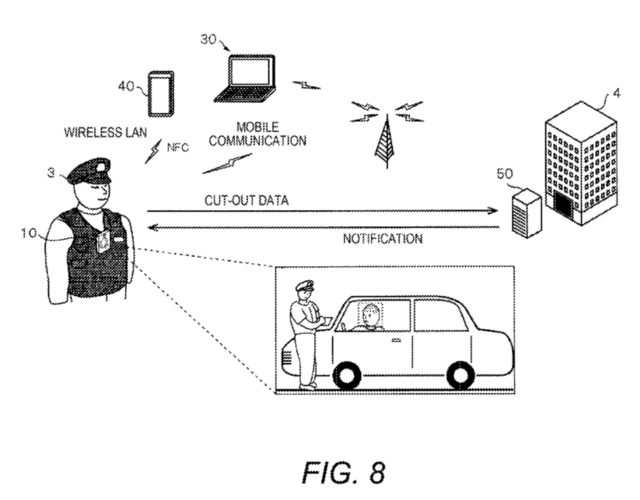

FIG. 8 is a diagram illustrating an example of an operation outline of wearable camera system 5 of the exemplary embodiment. Wearable camera 10 is connected to on-vehicle camera system 30 via near field communication (NFC) or the like. The cut-out data which is cut out from a frame of an image constituting a video captured by wearable camera 10 is transmitted to back end server 50 in police office 4 via on-vehicle camera system 30. The face image and GPS position information of a suspicious or doubtful person are included in the cut-out data. In addition, the face image data (that is, image-format data) of the face image of the suspicious or doubtful person is not included, but the face recognition data and the GPS position information which are formed of the information on the face features (that is, text-format data) indicating the features of the face of the person may be included in the cut-out data. On-vehicle camera system 30 is connected to wireless LAN access point 63 via the wireless LAN, and is connected to back end server 50 via a network such as Internet. The communication between on-vehicle camera system 30 and back end server 50 is performed through a secure communication path.

Here, the information on the face features will be described with reference to FIG. 13. FIG. 13 is an explanatory diagram specifically illustrating an example of face recognition data. As illustrated in FIG. 13, the face of the person is dependent on face recognition algorithm, but is mainly specified based on the shape of eyes, nose, and mouth, and the shortest distance between each of the eyes, the nose, and the mouth and a face outline. Note that, for the sake of convenience of description, the size of the left eye and the right eye of the person illustrated in FIG. 13 are set to be the same as each other.

Specifically, the information on the features including information on distances a, b, c, d, e, g, h, i, j, k, l, m, and n. Distance a indicates the shortest distance between the right eye and the face outline. Distance b indicates the distance between the right eye and the left eye. Distance c indicates the shortest distance between the left eye and the face outline. Distance d indicates the length of eye in a horizontal direction. Distance e indicates the length of the eye in a vertical direction. Distance g indicates the shortest distance between a right end of the nose and the face outline. Distance h indicates the shortest distance between a left end of the nose and the face outline. Distance i indicates the length of the nose in a vertical direction. Distance j indicates the shortest distance between a right end of a lip and the face outline. Distance k indicates the shortest distance between a left end of the lip and the face outline. Distance l indicates the shortest distance between a lower end of the lip and the face outline or a chin. Distance m indicates the length of the lip in the horizontal direction. Distance n indicates the length of the lip in the vertical direction. The information on the face features may not include all of the information on distances a, b, c, d, e, g, h, i, j, k, l, m, and n, and may include a portion of the information on distances a, b, c, d, e, g, h, i, j, k, l, m, and n as long as it is possible to specify at least the information on the eyes, the nose, and the mouth.

In a case where wearable camera 10 communicates with back end server 50, data may be directly transmitted to back end server 50 by using mobile communication such as long term evolution (LTE). In addition, in a case of using a tethering function of smart phone 40, wearable camera 10 may be connected to smart phone 40 which is a wireless LAN access point via the wireless LAN, and transmit the data to back end server 50 by using the mobile communication of smart phone 40. In this case, the communication mode of wearable camera 10 is set to be the station mode.

Back end server 50 performs the face recognition based on the face image data included in the cut-out data transmitted from wearable camera 10 or the face recognition data, and then collates the recognized face and the face registered in the suspicious person database. As the result of the collation, in a case where the aforementioned faces are matched with each other, back end server 50 notifies wearable camera 10 of the corresponding person data.

When receiving the notification of the person data, wearable camera 10 displays the face image and the information of the person registered in suspicious person database 58z on LCD 28 so as to notify police officer 3.

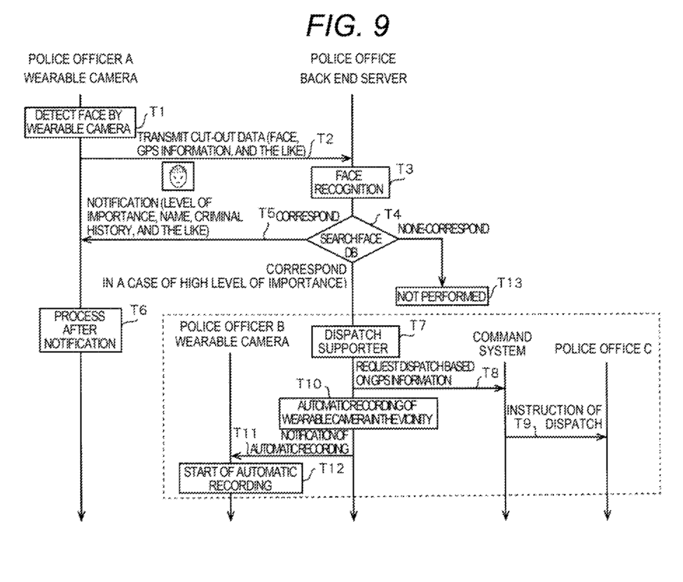

FIG. 9 is a sequence diagram illustrating an example of procedure of a specific operation of wearable camera system 5 of the exemplary embodiment. Here, in the description of FIG. 9, the police officers are distinguished as an individual person such that police officer 3 who is in patrol is set to be police officer A, police officer 3 who has rushed to the site in response to a dispatch instruction is set to be police officer B, and police officer 3 who has received an additional dispatch instruction is set to be police officer C.

Wearable camera 10 continuously captures the vicinity (for example, the site of the incident) while police officer A gets off from the patrol car, and patrols around the area. MCU 19 in wearable camera 10 performs a face detecting process for detecting the face of the person with respect to the captured image, and in a case where the face of the person is detected, a rectangular image mainly including the face in the image is cut out as a face image, and attribute information is added to the cut-out face image data so as to generate cut-out data (T1).

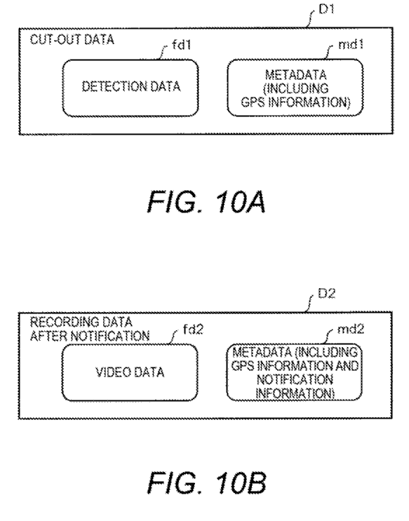

FIG. 10A is a diagram illustrating a configuration example of cut-out data D1. Cut-out data D1 includes detection data fd1 and metadata md1. Detection data fd1 includes the face image data or the face recognition data. Note that, detection data fd1 may include information relating to the specification of the suspicious person, for example, a license plate (a number plate). Metadata md1 includes information on the current date and time measured by RTC 17, and the position information (GPS information) obtained by GPS receiver 18.

MCU 19 transmits the cut-out data including the face image data and the GPS information to back end server 50 via communicator 21 (T2).

In back end server 50, communicator 53 receives the cut-out data transmitted from wearable camera 10. CPU 51 recognizes the face from the face image data included in the cut-out data by recognizer 51z (T3). CPU 51 searches suspicious person database 58z stored in storage 58 based on the recognized face, and determines whether or not the recognized face corresponds to the face registered in suspicious person database 58z (T4).

In a case where the recognized face corresponds to the face registered in suspicious person database 58z, CPU 51 notifies wearable camera 10 that the faces are matched (hit) with each other via communicator 53 as one example of a notifier (T5). The aforementioned notification includes metadata such as the level of importance of the person, the name, and the criminal history (the same applies hereinafter).

When wearable camera 10 is notified that the faces are matched with each other from back end server 50 via communicator 21, as a process after notification, MCU 19 displays face image 28z and specific information 28y of the person registered in suspicious person database 58z on the screen of LCD 28 (refer to FIG. 4) (T6).

For example, in a case where a background color of the screen of LCD 28 is red, the screen indicates the person who is at the highest level of importance (the most dangerous). In a case where the background color of the screen is yellow, the screen indicates the person who is at the slightly high level of danger. In a case where the background color of the screen is green, the screen indicates the person who is at the low level (safe) of danger. In addition, face image 28z of the person is displayed on the right side of the screen of LCD 28. The name, the state of being on the wanted list (WANTED), and the criminal history are displayed on the left side of the screen of LCD 28.

As described above, LCD 28 is disposed on the upper portion on the rear surface of housing 10z of wearable camera 10. Police officer 3 can look into the screen of LCD 28 only by slightly lowering the head, and roughly know the information of the suspicious person. With this, even in a case where the police officer confronts the suspicious person, the police officer can obtain the information on the suspicious person without giving a change of vigilance to the suspicious person. Accordingly, even when the suspicious person who is a criminal suddenly attacks the police officer, the police officer can promptly deal with the sudden attack.

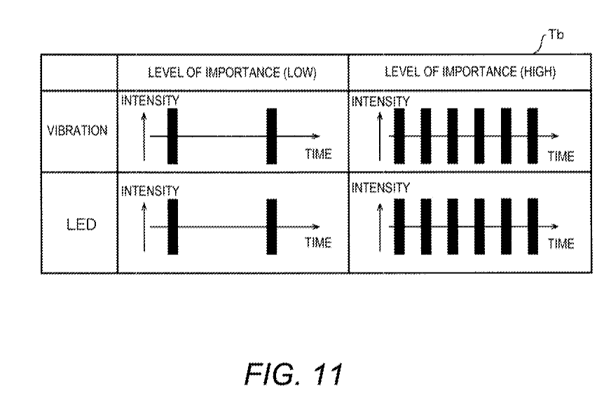

In addition, as a process after notification, MCU 19 performs the following operations in accordance with the level of danger. FIG. 11 is a diagram illustrating an example of registration contents in Table Tb in which operations of wearable camera 10 corresponding to the levels of importance after notification is registered. A vibrating pattern and a flashing pattern which correspond to the levels of importance are registered in Table Tb. Examples of the vibrating pattern include a pattern for changing a vibration period, vibration intensity, and the combination of the vibration period and the vibration intensity. Examples of the flashing pattern include a pattern for changing a flashing period, flashing intensity, and the combination of the flashing period and the flashing intensity.

In this regard, based on the notified data, in a case where the level of importance is low, vibrator 27 as one example of a vibrator vibrates in the vibrating pattern having a long intermittent vibration period, and in a case where the level of importance is high, vibrator 27 vibrates in the vibrating pattern having a short vibration period. In addition, based on the notified data, in a case where the level of importance is low, LEDs 26a to 26c as examples of a light source perform a flashing operation in the flashing pattern having a long flashing period, and in a case where the level of importance is high, LEDs 26a to 26c perform the flashing operation in the flashing pattern having a short flashing period.

Further, when receiving the notification from back end server 50, MCU 19 starts streaming distribution in which the video data of a video captured by capture 11 is transmitted to back end server 50 via streaming proxy server 65. Back end server 50 displays the video captured by wearable camera 10 on the screen of display 56 in real-time.

In procedure T4, in a case of an emergency situation, for example, the recognized face corresponds to the face registered in suspicious person database 58z, the level of importance of the corresponding person is the highest, and this person is a heavy criminal, wearable camera system 5 performs the operations in procedures T5 and T6 as described above, and additionally performs the following operations.

Back end server 50 determines the additional dispatch in accordance with the instruction of police officer 3 in police office 4 (T7). Back end server 50 requests for the dispatch from command system 90 based on the position information included in the metadata transmitted from wearable camera 10 (T8). When receiving the request of the dispatch from back end server 50, command system 90 instructs police officer C to be dispatched (T9). Police officer C rushes to the site of the incident when receiving the instruction of the dispatch.

Back end server 50 determines automatic recording of wearable camera 10 in the vicinity of the site so as to obtain the video in which the vicinity of the site (T10), and notifies wearable camera 10 belonging to police officer B in the vicinity of the site of the automatic recording (T11). When wearable camera 10 which is mounted on the uniform of police officer B receives the aforementioned notification, MCU 19 starts the operation of recording the video captured by capture 11 and the sound collected by microphone 29A in storage 15 (T12). FIG. 10B is a diagram illustrating a configuration example of recording data D2 after notification. Recording data D2 after notification includes video data fd2 and metadata md2 corresponding to video data fd2. Metadata md2 includes the GPS position information and specific information 28y (the name, the state of being on the wanted list, and the criminal history). That is, metadata md2 is data obtained by adding specific information 28y to metadata md1.

Further, the recording is performed from before a predetermined time (for example, 10 minutes) for receiving the notification data. That is, the video captured by the wearable camera is recorded so as to be repeatedly overwritten in a buffer memory (not shown) of RAM 13 for a predetermined period of time. When receiving the notification from back end server 50, wearable camera 10 uses the video data before being stored in the buffer memory for the predetermined period of time as an initial part of the recording data after notification. With this, wearable camera 10 can reliably record the video before and after situations relating to the suspicious person, and the video can be more valuable as an evidence video. Note that, the aforementioned predetermined time means a time which is optionally set in advance in accordance with the capacity of the buffer memory; however, the predetermined time may be changed after being once set.

In a case where back end server 50 notifies the automatic recording to wearable camera 10 belonging to police officer A, and may start the operation of the automatic recording, and even in a case where police officer A forgets to press recording switch SW1, or cannot press recording switch SW1, back end server 50 can record the video captured by wearable camera 10 which is the closest to the site of the incident.

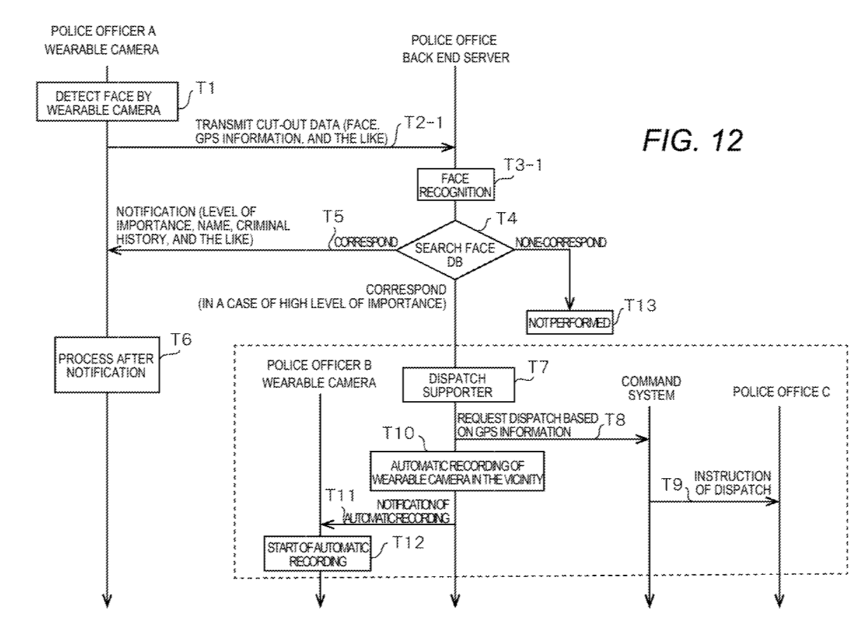

FIG. 12 is a sequence diagram illustrating another example of procedure of a specific operation of the wearable camera system of the exemplary embodiment. Here, in the description of FIG. 12, the contents which are the same as the descriptions of the respective processes in FIG. 9 are denoted by the same procedure numbers, the same description is simplified or omitted, and the different contents will be described. Similarly, in the description of FIG. 12, the police officers are distinguished as an individual person such that police officer 3 who is in patrol is set to be police officer A, police officer 3 who has rushed to the site in response to a dispatch instruction is set to be police officer B, and police officer 3 who has received an additional dispatch instruction is set to be police officer C.

In FIG. 12, the cut-out data transmitted from wearable camera 10 is different from the face image data as illustrated in FIG. 9, and includes the face recognition data formed of the information on the face features specified by wearable camera 10.

In FIG. 12, MCU 19 in wearable camera 10 performs the face detecting process for detecting the face of the person with respect to the captured image, and in a case of detecting the face of the person, the information on the features of the face is specified and cut out so as to generate the face recognition data formed of the information on the face features, and the cut-out data is generated by adding the attribute information to the face recognition data (T1).

MCU 19 transmits the cut-out data including the face recognition data and the GPS information to back end server 50 via communicator 21 (T2-1).

In back end server 50, communicator 53 receives the cut-out data transmitted from wearable camera 10. CPU 51 recognizes the face by obtaining the information on the face features from the face recognition data included in the cut-out data by recognizer 51z (T3-1). CPU 51 searches suspicious person database 58z stored in storage 58, and determines whether or not the recognized face corresponds to the face which is registered in suspicious person database 58z based on the recognized face (T4). The processes after procedure T4 in FIG. 12 is the same as the processes after procedure T4 in FIG. 9, and thus the description thereof will be omitted.

With this, in wearable camera system 5 of the exemplary embodiment, wearable camera 10 detects the face included in the image captured by capture 11, and cuts out the rectangular image (the face image) including the face as the information on the detected face of the person from the image, or cuts out the face recognition data which is formed of the information on the face features by specifying the information on the face features of the detected face of the person. Wearable camera 10 transmits the cut-out data including the face image data or the face recognition data to back end server 50. Back end server 50 receives the cut-out data from wearable camera 10, and collates the face image data included in the received cut-out data or the face of the person specified by the face recognition data with the face image registered in suspicious person database 58z. As the result of the collation, in a case where the face of the person specified by the received face image data or the face recognition data and the registered face image are matched with each other, back end server 50 notifies wearable camera 10 of the information on the person corresponding to the registered face image. Wearable camera 10 notifies police officer 3 of the notified information on the person. With this, wearable camera system 5 can rapidly inform the police officer that a suspicious person is in the vicinity, and thus it is possible to efficiently assist police officer 3 with their services. Accordingly, police officer 3 can take an appropriate action for protecting him or herself from the suspicious person.

In addition, wearable camera 10 obtains the position information from GPS receiver 18, and transmits the cut-out data which is obtained by adding the position information to the cut-out face image to back end server 50. With this, back end server 50 finds the location of police officer 3, and thus can be helpful to record the image captured by wearable camera 10 or to support other police officers.

In addition, wearable camera 10 changes the vibrating pattern of vibrator 27 in accordance with the notified information on the person. With this, police officer 3 can roughly grasp the information on the person from the vibration pattern of the sensed vibration without being noticed by the suspicious person. Accordingly, police officer 3 can promptly determine the appropriate action with respect to the suspicious person.

In addition, wearable camera 10 changes the flashing patterns of LEDs 26a to 26c in accordance with the notified information on the person. With this, police officer 3 can roughly grasp the information on the person from the flashing patterns of the LEDs without being noticed by the suspicious person. Accordingly, police officer 3 can promptly determine the appropriate action with respect to the suspicious person.

In addition, wearable camera 10 changes the background color (for example, the display state) of the screen of LCD 28 which is one example of the display in accordance with the level of importance of the notified information on the person. With this, police officer 3 promptly recognizes the level of importance without reading the information on the person expressed by text, and can take action with respect to the danger.

Further, wearable camera 10 reads up the notified information on the person so as to output as the sound from earphone terminal 29C. Police officer 3 previously puts on earphones which are one example of a sound output device connected to earphone terminal 29C so as to grasp the information on the person by the sound without being noticed by the suspicious person. Accordingly, the police officer can obtain the details of the information on the person.

Wearable camera 10 starts streaming distribution in which the video captured by capture 11 is transmitted to back end server 50 when the information on the person is notified. Accordingly, back end server 50 can display the video captured by wearable camera 10, and can transmit an instruction of appropriate action against the person who is reflected in the video to wearable camera 10.

Back end server 50 may notify another wearable camera of the information on the person, other than wearable camera 10 as described above. In addition, back end server 50 may transmit the information on the person to smart phone, other than wearable camera 10 as described above. In this case, back end server 50 can display the received information on the person on the display of smart phone.

Wearable camera 10 starts the recording of the video captured by capture 11 when the information on the person is notified. With this, wearable camera 10 can easily and reliably obtain an evidence video relating to a suspect involved in the incident in a case where an incident happens, for example.

Wearable camera 10 obtains the information on the face by deriving the information on the face features from the detected face of the person. With this, in a case where a state of a transmission line of the communication with back end server 50 is not satisfactory, wearable camera 10 can rapidly transmit the cut-out data including the face recognition data which is a text-format file to back end server 50 as compared with the case of transmitting the cut-out data including the face image data which is an image-format file to back end server 50. In other words, it is possible to decrease the amount of information transmitted to back end server 50 from wearable camera 10. Further, when the face recognition data is transmitted from wearable camera 10, back end server 50 does not require the face recognition process (for example, a process of extracting the information on the face features) which is supposed to be performed at the time of recognizing a face of the person from face image data, and thus it is possible to decrease processing loads in back end server 50.

Wearable camera 10 obtains the information on the face by cutting out the detected face image of the person from the captured image of the subject. With this, in a case where a state of a transmission line of the communication with back end server 50 is satisfactory, wearable camera 10 can rapidly transmit the cut-out data including the face image data which is an image-format file to back end server 50.

Although embodiments have been described with reference to the accompanying drawings, it is to be understood that the present disclosure is not limited thereto. It is obvious that those skilled in the art can conceive various changes and modifications within the scope described in the claims, and it is understood that the aforementioned various changes and modifications naturally belong to the technical scope of the present disclosure.

For example, in the above-described embodiment, the face image of the suspicious person is cut out and the information on the person of the suspicious person is notified to the wearable camera by using the suspicious person database; however, without limiting to the face image, the same process may be performed by cutting out any image relating to the specification of the suspicious person, such as an image of a license plate. With this, opportunities to discover a suspicious person or a stolen vehicle are increased, which leads to crime prevention.

In a case where the network connection environment is not available in the site, the police officer may return to the police office so as to connect the wearable camera to the network, and in this case, the back end server recognizes the video captured by the wearable camera after notification of the incident.

In the above-described exemplary embodiment, when the back end server requests for the dispatch, the command system determines police officers (supporters) to be dispatched; however, the back end server may request for the dispatch by specifying the supporter based on the position information (position information using GPS) of the police officer. In a case where the position information by GPS is not confirmed, the back end server may specify the supporter based on destination information.

In addition, in the above-described exemplary embodiment, when being notified of the information on the suspicious person from the back end server, the wearable camera starts the streaming distribution, and automatically starts the recording; however, in addition to the aforementioned operations, setting information stored in setting data file 15z of the wearable camera may be changed so as to enhance the resolution. With this, it is possible to more clearly capture the video by using the wearable camera.

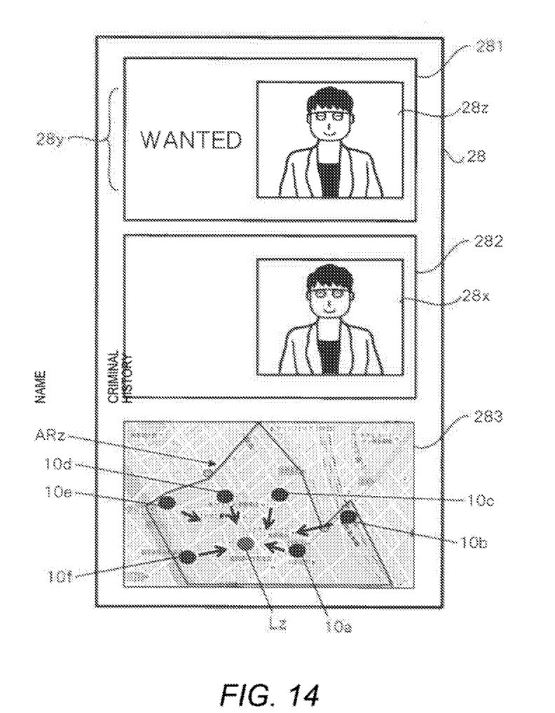

Next, a modified example (hereinafter, referred to a “modification example”) of the above-described exemplary embodiments will be described with reference to FIG. 14 to FIG. 16. In the following description, the description relating to the same processing contents as those of the above-described exemplary embodiments will be simplified or omitted, and different contents will be mainly described.

In the modification example, in addition to the operation of the above-described exemplary embodiment, in a case where it is determined that the recognized face corresponds to the face registered in suspicious person database 58z, back end server 50 notifies wearable cameras which include wearable camera 10 transmitting the cut-out data of the information on the person having the corresponding face.

FIG. 14 is a diagram illustrating a display example of a screen displayed on the wearable camera or the smart phone of the modification example. LCD 28 as illustrated in FIG. 14 may be LCD 28 of wearable camera 10 illustrated in FIG. 5, or may be a LCD of smart phone 40 which is carried by police officer 3 who has wearable camera 10 mounted on his or her uniform or carries wearable camera 10 (refer to FIG. 1). In other words, three types of screens 281, 282, and 283 as illustrated in FIG. 14 may be displayed on LCD 28 of wearable camera 10, or may be displayed on smart phone 40 which is carried by police officer 3 who has wearable camera 10 mounted on his or her uniform or carries wearable camera 10.

As described with reference to FIG. 4 in the above-described exemplary embodiment, in the case where the information on the suspicious person is registered in suspicious person database 58z of back end server 50, face image 28z and specific information 28y of the suspicious person are displayed on screen 281. Note that, in a case where screen 281 is displayed on smart phone 40, in addition to the three types of information of “name”, “WANTED”, and “criminal history” as illustrated in FIG. 14, the information on the same person registered in suspicious person database 58z, which is transmitted from back end server 50 may be displayed as specific information 28y by an operation such as scrolling or tapping by police officer 3.

Actually captured image 28x of the suspicious person (for example, the suspect, who is involved in the incident, on the run) captured by police officer 3 with wearable camera 10 in the actual incident site is displayed on screen 282. With this, when viewing captured image 28x displayed on screen 282, the police officer can easily get an overview of the upper body including the face of the suspicious person and current clothes of the suspicious person, and thus it is possible to efficiently search the suspicious person so as to early find the suspicious person.

Map information including position Lz in which the suspicious person (for example, the suspect, who is involved in the incident, on the run) is captured by police officer 3 with wearable camera 10 is displayed on screen 283. In addition, the map information may be displayed on wearable camera 10 or smart phone 40 which is used by police officer 3, and may be distributed from back end server 50 with respect to all of wearable cameras 10a, 10b, 10c, 10d, 10e, and 10f in predetermined range ARz including position Lz. With this, in predetermined range ARz including position Lz of the incident site, the police officer who has the wearable camera, which is positioned at position Lz, mounted on his or her uniform, or carries the wearable camera can rapidly direct to position Lz of the incident site, and the police officer who can rush to the site can properly support (for example, dispatch) police officer 3 who is in the incident site, and thus can early secure the suspect.

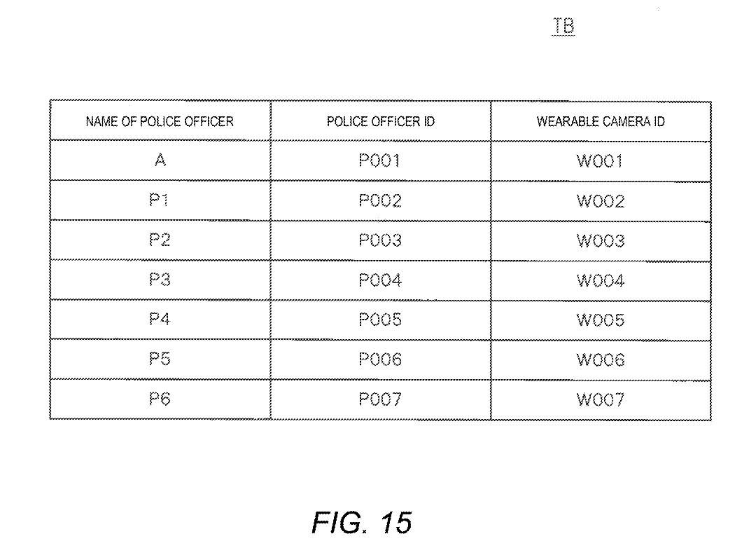

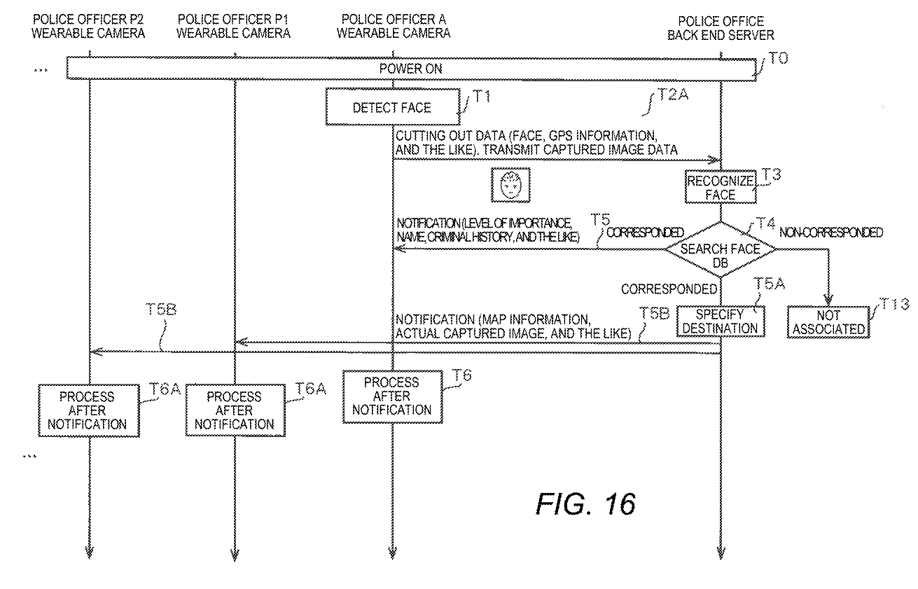

FIG. 15 is a diagram illustrating an example of team organization correspondence table TB of police officers of a team to which police officer A belongs and wearable cameras used by the police officers of the aforementioned team. In the following description, as illustrated in FIG. 9 and FIG. 16 described below, police officer A is a police officer who encounters a suspicious person (for example, the suspect, who is involved in the incident, on the run) in the incident site, and captures the suspicious person by using wearable camera 10 which mounted on his or her uniform or carried by the police officer.

Team organization correspondence table TB is generated for each team (in other words, a group) provided in police office 4. Team organization correspondence table TB which is associated to the team to which police officer A belongs is defined by names of the police officers belonging to the same team, identification information (ID: identification) of the police officers, and identification information (ID) of wearable cameras used by the police officers in association with each other. Team organization correspondence table TB is stored in storage 58 of back end server 50. In addition, team organization correspondence table TB may be previously generated in a stage in which a team is organized by the organizational changes or the like in police office 4, or may be generated in a stage in which the police officer ID and the wearable camera ID are associated with each other by an operation of each of the police officer via client PC 70 (so-called back end client) or the like in police office 4 before all of the police officers including police officer A who belong to the team rush into the incident site.

In the modification example, screen 283 displaying the map information as illustrated in FIG. 14 is distributed from back end server 50 with respect to wearable cameras 10a, 10b, 10c, 10d, 10e, and 10f which are used by the police officers (for example, total six police officers including police officer A) in the team to which police officer A belongs, and then is displayed on each of the wearable cameras.

Meanwhile, in team organization correspondence table TB illustrated in FIG. 15, wearable camera IDs “W001”, “W002”, “W003”, “W004”, “W005”, “W006”, and “W007” correspond to “wearable camera 10”, “wearable camera 10a”, “wearable camera 10b”, “wearable camera 10c”, “wearable camera 10d”, “wearable camera 10e”, and “wearable camera 10f” as illustrated in FIG. 14, for example. In other words, screen 283 displaying the map information as illustrated in FIG. 14 has a function of instructing police officers P1, P2, P3, P4, P5, and P6 respectively having police officer IDs “P002”, “P003”, “P004”, “P005”, “P006”, and “P007” to support (dispatch) police officer A having police officer ID “P001” in the incident site.

Note that, although not described in team organization correspondence table TB illustrated in FIG. 15, identification information (for example, ID) of the smart phone which is carried by each of police officers A, P1, P2, P3, P4, P5, and P6 respectively having police officer IDs “P001”, “P002”, “P003”, “P004”, “P005”, “P006”, and “P007” may be also added so as to be registered. In this case, back end server 50 may transmit display data of screens 281, 282, and 283 illustrated in FIG. 14 to the smart phone instead of the wearable cameras of the police officers. With this, in a case where display areas of screens 281, 282, and 283 of the smart phone is larger than those of the wearable camera, the police officers can specifically confirm various contents of screens 281, 282, and 283 by viewing the smart phone rather than the wearable camera.

FIG. 16 is a sequence diagram illustrating an example of a specific operation procedure of wearable camera system 5 of the modification example.

In the illustration of FIG. 16, the description of the same process as that of FIG. 9 is simplified by denoting the same process number or omitted, and different contents are mainly described. In addition, FIG. 16 only illustrates a process with respect to police officers P1 and P2 as the police officers in the team to which police officer A belongs; however, the illustration of the aforementioned process is applicable to a process with respect to the wearable cameras mounted on uniform of or carried by other police officers P3, P4, P5, and P6 who belong to the same team.

As a premise of the description of FIG. 16, powers of all of wearable cameras 10, 10a, 10b, and . . . , and back end server 50 are turned ON (T0).

After procedure T0, a process of procedure T1 is performed in wearable camera 10. MCU 19 transmits not only cut-out data including face image data, GPS information, and the like, but also an actually captured image to back end server 50 via communicator 21 (T2A). After procedure T2A, a process of procedure T3 is performed in back end server 50.

In a case where the recognized face corresponds to the face registered in suspicious person database 58z, CPU 51 notifies that the faces are matched (hit) with each other via communicator 53 as one example of a notifier to wearable camera 10 (T5). The aforementioned notification includes metadata such as the level of importance of the person, the name, and the criminal history (the same applies hereinafter).

In addition, in a case where the recognized face corresponds to the face registered in suspicious person database 58z, back end server 50 specifies the wearable camera which becomes a destination to which the information of screens 281, 282, and 283 illustrated in FIG. 14 is notified (T5A).

Here, as a specifying method of the wearable camera which becomes a destination in procedure T5A, two methods can be exemplified.

In a first method, back end server 50 specifies all of the wearable cameras in a predetermined range including the position of wearable camera 10 as a destination by using GPS information (that is, the position information of wearable camera 10) transmitted from wearable camera 10 in procedure T2. That is, as displayed on screen 283 in FIG. 14, back end server 50 specifies all of wearable cameras 10a, 10b, 10c, 10d, 10e, and 10f in predetermined range ARz including position Lz as a destination. The predetermined range is within 1 km radius around position Lz; however, 1 km radius is merely an example, and the value of the range is not limited thereto. With this, back end server 50 can instruct all of the police officers in a place close to the position Lz to rapidly rush to the incident site. In other words, police officer A can be rapidly supported (dispatch) by all of the police officers in the vicinity, and thus it is possible to rapidly secure the suspicious person (for example, the suspect, who is involved in the incident, on the run), which leads to early resolution of the incident.

In a second method, back end server 50 specifies wearable cameras 10a, 10b, 10c, 10d, 10e, and 10f which are used by the all of the police offices in the team and includes identification information (wearable camera ID) of wearable camera 10 which is transmitted from wearable camera 10 in procedure T2 or identification information (police officer ID) of police officer A using wearable camera 10 as a destination, with reference to team organization correspondence table TB as illustrated in FIG. 15. With this, back end server 50 can instruct all of the police officers, in the team to which police officer A belongs, in position Lz to rapidly rush to the incident site. In other words, for example, in a case where an area under the control by each team is previously determined, police officer A can be rapidly supported (dispatch) by all of the police officers who belong to the same team as that of police officer A, and thus it is possible to rapidly secure the suspicious person (for example, the suspect, who is involved in the incident, on the run), which leads to early resolution of the incident.

Back end server 50 notifies wearable camera (specifically, wearable cameras used by police officers P1, P2, and . . . in addition to police officer A) which becomes the destination specified in procedure T5A of the information on the person registered in suspicious person database 58z (for example, metadata such as the level of importance of the person, the name, and the criminal history), map information, and actually captured image of the suspicious person (for example, the captured image transmitted from wearable camera 10 in procedure T2A) (T5B).

Wearable camera 10 receives the notification including the fact that the image is hit from back end server 50 via communicator 21. At this time, as the process after notification, the screen of LCD 28 (refer to FIG. 14), MCU 19 displays screen 281 of face image 28z of the person registered in suspicious person database 58z and specific information 28y, screen 282 of actually captured image 28x of the suspicious person, and screen 283 displaying the map information of the incident site where the suspicious person is present (T6).

In addition, similar to the above description, wearable cameras 10a, 10b, and . . . used by police officers P1, P2, and . . . receive the notification including the fact that the image is hit from back end server 50. At this time, MCU 19 displays screen 281 of face image 28z of the person registered in suspicious person database 58z and specific information 28y, screen 282 of actually captured image 28x of the suspicious person, and screen 283 displaying the map information of the incident site where the suspicious person is present on the screen of LCD 28 (refer to FIG. 14) (T6A).

As described above, in wearable camera system 5 of the modification example, wearable camera 10 (a first wearable camera) captures a subject (for example, the incident site where the suspicious person is present), detects the face of the person included in the captured image of the captured subject, and then transmits the detected information on the face to back end server 50. Back end server 50 registers suspicious person database 58z in which the face image of the person involved in the incident and the information on the person are associated with each other in storage 58 as one example of a storage, and collates the information on the face transmitted from wearable camera 10 with storage 58. In a case where a face of a person specified based on the information on the face is registered in suspicious person database 58z of storage 58, back end server 50 notifies the plurality of wearable cameras including wearable camera 10 of the information on the suspicious person registered in suspicious person database 58z. The plurality of wearable cameras which are notified by back end server 50 notifies the police officer who has the wearable camera mounted on his or her uniform, or carries the wearable camera of the notified information on the suspicious person. With this, wearable camera system 5 can rapidly notify that the suspicious person is present in the vicinity to not only police officer A, but also other police officers in addition to police officer A, and thus it is possible to rapidly instruct other polices to support (dispatch) police officer A. Therefore, it is possible to support early securing of the suspicious person (for example, the suspect, who is involved in the incident, on the run).

Further, wearable camera 10 obtains the position information of the master device, and then transmits the information on the face of the suspicious person, to which the position information of wearable camera 10 is added, to back end server 50. Back end server 50 notifies all of the wearable cameras including wearable camera 10 in predetermined range ARz of the position information transferred from wearable camera 10. With this, back end server 50 can instruct all of the police officers in a place close to position Lz to rapidly rush to the incident site. In other words, police officer A can be rapidly supported (dispatch) by all of the police officers in the vicinity, and thus it is possible to rapidly secure the suspicious person (for example, the suspect, who is involved in the incident, on the run), which leads to early resolution of the incident.

In addition, wearable camera 10 stores identification information (wearable camera ID) of wearable camera 10 in storage 15, and then transmits the information on the face of the suspicious person, to which the wearable camera ID is added, to back end server 50. Back end server 50 stores team organization correspondence table TB in which the identification information of the police officers who belong to a group (team) and the identification information of the wearable cameras used by the police officers are associated with each other in storage 58. Back end server 50 notifies the stored team organization correspondence table TB to all of the wearable cameras which are associated with the team to which police officer A belongs, which corresponds to the wearable camera ID transmitted from wearable camera 10. With this, back end server 50 can instruct all of the police officers, in the team to which police officer A belongs, in position Lz to rapidly rush to the incident site by using the wearable camera ID of wearable camera 10. In other words, in a case where an area under the control by each team is previously determined, police officer A can be rapidly supported (dispatch) by all of the police officers who belong to the same team as that of police officer A, and thus it is possible to rapidly secure the suspicious person (for example, the suspect, who is involved in the incident, on the run), which leads to early resolution of the incident.

Further, wearable camera 10 stores identification information (police officer ID) on police officer A who uses wearable camera 10 in storage 15, and then transmits the information on the face of the suspicious person, to which the police officer ID is added, to back end server 50. Back end server 50 stores team organization correspondence table TB in which the identification information of the police officers who belong to a group (team) and the identification information of the wearable cameras used by the police officers are associated with each other to storage 58. Back end server 50 notifies the stored team organization correspondence table TB to all of the wearable cameras which are associated with the team to which police officer A belongs, which corresponds to the police officer ID transmitted from wearable camera 10. With this, back end server 50 can instruct all of the police officers, in the team to which police officer A belongs, in position Lz to rapidly rush to the incident site by using the police officer ID of police officer A. In other words, for example, in a case where an area under the control by each team is previously determined, police officer A can be rapidly supported (dispatch) by all of the police officers who belong to the same team as that of police officer A, and thus it is possible to rapidly secure the suspicious person (for example, the suspect, who is involved in the incident, on the run), which leads to early resolution of the incident.

Further, wearable camera 10 obtains the position information of the master device, and then transmits the information on the face of the suspicious person, to which the position information of wearable camera 10 is added, to back end server 50. Back end server 50 notifies the plurality of wearable cameras of the map information including the information on the suspicious person registered in storage 58 and the position information of wearable camera 10. With this, in predetermined range ARz including position Lz of the incident site, the police officer who has the wearable camera, which is positioned at position Lz, mounted on his or her uniform, or carries the wearable camera can rapidly direct to position Lz of the incident site, and the police officer who can rush to the site can properly support (for example, dispatch) police officer 3 who in the incident site, and thus can early secure the suspect.

In addition, back end server 50 notifies the plurality of wearable cameras of the information on the suspicious person registered in storage 58 and captured image including the face of the suspicious person which is captured by wearable camera 10. With this, when viewing captured image 28x displayed on screen 282, the police officer can easily get an overview of the upper body including the face of the suspicious person and current clothes of the suspicious person, and thus it is possible to efficiently search the suspicious person so as to early find the suspicious person.

1. A wearable camera system comprising:
a wearable camera which belongs to a user;
an on-vehicle camera system which is installed on a patrol car or the like, and is capable of communicating with the wearable camera; and
a server which is capable of communicating with the wearable camera and the on-vehicle camera system,
wherein the on-vehicle camera system captures a subject, detects a face of a person included in a captured image of the captured subject, and transmits information on the detected face to the server,
wherein the server receives the transmitted information on the face, collates information on a face of a person involved in an incident which is registered in advance with the received information on the face, and notifies the wearable camera of the information on the person involved in the incident in a case where the received information on the face is matched with the information on the face of the person involved in the registered incident from the result of the collation, and
wherein the wearable camera notifies the user of the notified information on the person.

2. The wearable camera system of claim 1, wherein the on-vehicle camera system obtains position information of a master device, and transmits the information on the face to the server together with the position information.

3. The wearable camera system of claim 1, wherein the wearable camera which includes a vibrator for vibrating notifies the user of the information on the person by changing a vibrating pattern so as to cause the vibrator to vibrate in accordance with the notified information on the person.

4. The wearable camera system of claim 1, wherein the wearable camera which includes a light source for flashing notifies the user of the information on the person by changing a flashing pattern so as to cause the light source to flash in accordance with the notified information on the person.

5. The wearable camera system of claim 1, wherein the wearable camera displays the notified information on the person, and displays the information on the person by changing a display type in accordance with a level of importance of the notified information on the person.

6. The wearable camera system of claim 1, wherein the wearable camera outputs a sound corresponding to the notified information on the person.

7. The wearable camera system of claim 1, wherein the wearable camera starts streaming distribution of a video based on the captured image to the server in accordance with the notification of the information on the person from the server.

8. The wearable camera system of claim 1, wherein the wearable camera starts recording of the captured image in accordance with the notification of the information on the person from the server.

9. The wearable camera system of claim 1, wherein the on-vehicle camera system obtains the information on the face by deriving the information on the face features from the detected face.

10. The wearable camera system of claim 1, wherein the on-vehicle camera system obtains the information on the face by cutting out the detected face image of the person from the captured image of the captured subject.

11. A method of notifying person in wearable camera system including a wearable camera which belongs to a user; an on-vehicle camera system which is installed on a patrol car or the like, and is capable of communicating with the wearable camera; and a server which is capable of communicating with the wearable camera and the on-vehicle camera system,
wherein the on-vehicle camera system captures a subject, detects a face of a person included in a captured image of the captured subject, and transmits information on the detected face to the server,
wherein the server receives the transmitted information on the face, collates information on a face of a person involved in an incident which is registered in advance with the received information on the face, and notifies the wearable camera of the information on the person involved in the incident in a case where the received information on the face is matched with the information on the face of the person involved in the registered incident from the result of the collation, and
wherein the wearable camera notifies the user of the notified information on the person.

12. A wearable camera system in which a first wearable camera which is capable of being mounted on a uniform of a police officer or is capable of being carried by the police officer is communicably connected to a sever,
wherein the first wearable camera captures a subject, detects a face of a person included in a captured image of the captured subject, and transmits information on the detected face to the server,
wherein the server registers a face image of a person involved in an incident and information on the person in association with each other in a storage, collates the transmitted information on the face with the storage, and in a case where a face of a person specified based on the information on the face is registered in the storage, notifies a plurality of wearable cameras which include the first wearable camera of the information on the person registered in the storage, and
wherein the plurality of wearable cameras notify the information on the person notified from a notifier of a police officer who has the wearable camera mounted on his or her uniform, or carries the wearable camera.

13. The wearable camera system according to claim 12,
wherein the first wearable camera obtains position information of a master device, and transmits the information on the face to which the position information is added to the server, and
wherein the server notifies all of the wearable cameras including the first wearable camera in a predetermined range of the transmitted position information.

14. The wearable camera system according to claim 12,
wherein the first wearable camera stores identification information of the first wearable camera in a storage, and then transmits information on the face, to which identification information of the first wearable camera is added, to the server, and
wherein the server stores, a table in which identification information of the police officers who belong to a group and identification information of the wearable cameras used by the police officers are associated with each other in the storage, and then notifies the stored table to all of the wearable cameras which are associated with the group to which a police officer belongs, which corresponds to the transmitted identification of the first wearable camera.

15. The wearable camera system according to claim 12,
wherein the first wearable camera stores identification information of a police officer who uses the first wearable camera in the storage, and then transmits information on the face, to which identification information of the police officer is added, to the server, and
wherein the server stores, a table in which identification information of the police officers who belong to a group and identification information of the wearable cameras used by the police officers are associated with each other in the storage, and then notifies the stored table to all of the wearable cameras which are associated with the group to which a police officer belongs, which corresponds to the transmitted identification information of the police officer.

16. The wearable camera system according to claim 12,
wherein the first wearable camera obtains position information of a master device, and transmits the information on the face, to which the position information is added, to the server, and
wherein the server notifies the plurality of wearable cameras of map information including the information on the person registered in storage and the position information.

17. The wearable camera system according to claim 12, wherein the server notifies the plurality of wearable cameras of the information on the person registered in the storage and a captured image including a face of the person captured by the first wearable camera.

18. A method of notifying a person in a wearable camera system in which a first wearable camera which is capable of being mounted on a uniform of a police officer or carried by the police officer is communicably connected to a sever,
wherein the first wearable camera captures a subject, detects a face of a person included in a captured image of the captured subject, and transmits information on the detected face to the server,
wherein the server registers a face image of person involved in an incident and information on the person in association with each other in a storage, collates the transmitted information on the face with the storage, and in a case where a face of a person specified based on the information on the face is registered in the storage, notifies a plurality of wearable cameras which include the first wearable camera of the information on the person registered in the storage, and
wherein the plurality of wearable cameras notify the information on the person notified from a notifier of a police officer who has the wearable camera mounted on his or her uniform, or carries the wearable camera.
